(19) United States
(12) Patent Application Publication
(10) Pub. No.: US 2026/0153848 A1
(43) Pub. Date: Jun. 4, 2026

(54) Maintenance Mode in a Functional Safety Device

(71) Applicant: Rockwell Automation Asia Pacific Business Center Pte. Ltd., Singapore (SG)

(72) Inventors: Chia Leong Chin, Singapore (SG); Rosh Chathoth Sreedharan, The Colony, TX (US); Wen Chinn Yew, Singapore (SG)

(21) Appl. No.: 18/968,299

(22) Filed: Dec. 4, 2024

(51) Int. Cl. G05B 19/042

(52) U.S. Cl. CPC G05B 19/0425

(57) ABSTRACT

A module for a safety controller includes multiple channels for either input signals or output signals. The module also includes multiple terminals, where each terminal corresponds to one of the channels. A processor in the module generates at least one test signal and provides the at least one test signal to each of the channels to detect proper operation of each of the channels while either receiving input signals or providing output signals at each of the terminals. One of the channels is identified as an override channel. The at least one test signal is selectively disabled to the override channel.

### BACKGROUND INFORMATION

The subject matter disclosed herein relates to a maintenance mode provided in a module for a safety industrial controller. More specifically, a maintenance mode is provided for a safety industrial controller which permits temporarily disabling a functional safety check for an individual channel of an input or an output module while maintaining operation of the channel to continue operation of the safety industrial controller during maintenance of the individual channel.

Industrial controllers are specialized computer systems used for the control of industrial processes or machinery, for example, in a factory environment. Generally, an industrial controller executes a stored control program that reads inputs from a variety of sensors associated with the controlled process and machine and, sensing the conditions of the process or machine and based on those inputs and a stored control program, calculates a set of outputs used to control actuators controlling the process or machine.

Industrial controllers differ from conventional computers in a number of ways. Physically, they are constructed to be substantially more robust against shock and damage and to better resist external contaminants and extreme environmental conditions than conventional computers. The processors and operating systems are optimized for real-time control and are programmed with languages designed to permit rapid development of control programs tailored to a constantly varying set of machine control or process control applications.

Under the direction of a stored program, the industrial controller examines a series of inputs from sensors corresponding to the status of the controlled process and changes a series of outputs to actuators controlling the industrial process. The sensor inputs may be binary, that is on or off, for example, from a limit switch, or may be analog, that is, providing a multi-valued output that may vary within a continuous range, for example, from a temperature sensor, camera, or the like. Similarly, the actuator outputs may be binary, for example, controlling a solenoid or shut off valve, or analog controlling a metering valve, motor, linear positioning element, or the like. Typically, analog signals are converted to binary words for processing.

An important application of industrial controllers is in “safety control”. Safety control is used in applications where failure of an industrial controller can create a risk of injury to humans. While safety control is closely related to reliability, safety control places additional emphasis on ensuring correct operation even if it reduces equipment availability. Safety industrial control systems are not optimized for “availability”, that is being able to function for long periods of time without error, but rather for “safety” which is being able to accurately detect error to shut down. Safety industrial controllers normally provide a predetermined safe state for their outputs upon a safety shutdown, the predetermined values of these outputs being intended to put the industrial process into its safest static mode. For that reason, safety controllers may provide run time diagnostic capabilities to detect incorrect operation and to move the control system to predefined “safety states” if a failure is detected. The safety states will depend on the particular process being implemented and causes the actuators to assume a state predetermined to be safest when control correctness cannot be ensured. For example, upon detection of a failure, an actuator controlling cutting machinery might move that machinery to a stop state while an actuator providing air filtration might retain that machinery in an on state.

Safety control capability may be designated, for example, by “safety integrity levels” (SIL) defined under standard IEC 61508 and administered by the International Electrotechnical Commission (IEC) under rule hereby incorporated by reference. Standard IEC EN 61508 defines four SIL levels of SIL-1 to SIL-4 with higher numbers representing higher amounts of risk reduction. Obtaining a desired SIL rating requires a certain degree of diagnostic coverage for components within a system. The degree of diagnostic coverage is defined according to a percentage likelihood that a failure of a component within a system will be detected. Low diagnostic coverage, for example, may require only a sixty percent (60%) chance that a failure will be detected. In contrast, high diagnostic coverage, required for a SIL 3 rating, may require a ninety-nine percent (99%) chance that a failure will be detected. Mitigation of a risk occurring increases the SIL rating and may be achieved by detecting a failure in a system that may cause a dangerous operating environment before the dangerous operating environment can occur. Therefore, determination of a SIL rating is based, at least in part, on the ability of a system to detect a fault condition and enter a safe state in response to detecting the fault condition.

In some applications, an input or an output channel may remain in a constant state for an extended period of time, such as days or weeks as a process continually operates. If the input or output channel were to fail during the extended operation in a manner that kept the channel at the present state, the failure would not be detected until the end of this operating period. However, to achieve a desired SIL rating, it may be necessary to detect failure of the input or output channel during this extended operation.

As is known to those skilled in the art, the diagnostic coverage required to obtain a desired SIL rating may be provided by periodic testing of an input or output channel for the safety industrial controller and monitoring operation of the input or output channel. A test signal may be provided to the input or output channel, where the test signal causes the input or output channel to change states. If the test signal is supplied to an input channel, the value of the input channel being supplied to the control program may be held at its last state as the test signal is supplied. The control program is, therefore, unaware of the channel changing state due to the test signal and takes no action as a result of the change in state of the input. The duration of the test signal may be milliseconds or microseconds such that no significant delay is incurred by the control program in detecting an actual change of state from the controlled system. If the test signal is supplied to an output channel, the test signal may be provided at a frequency that is faster than the response time of a device connected to the output channel. For example, the output channel may be used to power a relay or other solenoid. The test signal causes the output channel to transition from an on state to an off state and back to an on state faster than the response time of the relay. The relay, therefore, remains in the on state throughout the application of the test signal. Nevertheless, the safety controller is able to observe the transition in state of the output channel and verify the output channel is operational.

In some applications, preventive maintenance may be scheduled or failure of a non-critical device may have been detected, and it may be desired to perform the maintenance or replace the non-critical device without shutting down the entire controlled machine or process. A total shut down may require, for example, cooling a furnace, emptying a production line, or some other activity that generates significant down time and lost profit. If the maintenance or repair may be performed without the total shut down, lost time or profit is reduced or eliminated.

While the technician is performing the repair, the technician may temporarily bypass operation of the safety controller. For example, the technician may supply a control voltage to a device to enable operation of the device while an intermediate relay is removed and replaced. In other instances, a sensor may need replacing where the sensor generates a feedback signal corresponding to an operating state of the controlled machine or process. The safety controller may utilize the feedback signal to control operation of a motor or other actuator on the controlled machine or process. The technician may supply a constant voltage to the motor or actuator for continuous operation while the sensor is being replaced to ignore the temporary loss of the feedback signal.

However, providing an external control voltage to a device in the controlled system is not without certain disadvantages. The external control voltage is not subject to the diagnostic coverage required by the safety controller. While the external control voltage is being supplied, a test signal provided to an input or output channel may go undetected. The external control voltage will maintain a constant value and will not change state as a result of the test signal. If the channel receives a test signal while the maintenance is being performed, a failure on the channel will be detected and the controlled machine or process will be brought to the safe state. This result is contrary to the desired performance of the controlled machine or process. Maintenance is being performed while the controlled machine or process is operating to avoid shutting down the controlled system.

Thus, it would be desirable to provide a maintenance mode for a safety controller to permit maintenance on a portion of the controlled machine or process while the remainder of the controlled machine or process continues operation.

### BRIEF DESCRIPTION

According to one embodiment of the invention, a module for a safety controller includes multiple channels for either input signals or output signals, multiple terminals, where each terminal corresponds to one of the plurality of channels, and a processor. The processor is operative to generate at least one test signal and to provide the at least one test signal to each of the channels to detect proper operation of each of the channels while either receiving the input signals or providing the output signals at each of the terminals. The processor is further operative to selectively disable the at least one test signal provided to one of the channels.

According to another embodiment of the invention, a method for disabling a diagnostic test for a module in a safety controller includes identifying an override channel for the module, where the override channel is selected from multiple channels for either input signals or output signals. At least one test signal is generated and provided to each of the channels to detect proper operation of each channel while either receiving the input signals or providing the output signals. The at least one test signal, provided to the override channel, is selectively disabled.

According to still another embodiment of the invention, a system for disabling a diagnostic test for a module in a safety controller includes a controller module and an output module. The controller module includes a memory storing multiple instructions and a processor configured to execute the instructions to generate multiple output signals. The output module includes multiple channels and multiple terminals, where each terminal corresponds to one of the channels. The output module also includes a processor operative to receive the output signals from the controller module and to generate at least one test signal. The processor provides the at least one test signal to each of the channels to detect proper operation of each channel while receiving the output signals. The processor selectively disables the at least one test signal provided to one of the channels.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is a block diagram of one embodiment of an industrial control system;

FIG. 2 is a block diagram further representing aspects of the industrial control system of FIG. 1;

FIG. 3 is a block diagram further representing output logic for a module in the industrial control system of FIG. 1;

FIG. 4 is a timing diagram for a plurality of test signals provided on output channels of an output module in the industrial control system of FIG. 1; and

FIG. 5 is a timing diagram for a plurality of test signals provided on output channels of an output module illustrating one of the channels being bypassed according to one embodiment of the present invention.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are explained more fully with reference to the non-limiting embodiments described in detail in the following description.

The subject matter disclosed herein describes a maintenance mode for a safety controller to permit maintenance on a portion of the controlled machine or process while the remainder of the controlled machine or process continues operation. At least one test signal is applied to multiple input and/or output channels of the safety controller. The test signal is a diagnostic signal used to verify that the channel is capable of changing state. During maintenance, an external control voltage may be utilized to maintain operation of a portion of the controlled machine or process while one or more devices are repaired or replaced. Without the external control voltage, the temporary removal or adjustment of the devices being repaired or replaced would cause the controlled machine or process to stop normal operation, either entering a safe state or suspending operation entirely. The external control voltage, however, also prevents the test signal from performing the desired verification of each input and/or output channel. If the test signal is applied to a channel receiving the external control voltage, the channel does not change state and the safety controller will detect a failure of the channel, directing the safety controller to enter a safe operating state.

The present invention allows individual channels to be identified for a maintenance mode. In the maintenance mode, the test signal is temporarily suspended. An external control voltage may be supplied and the safety controller will not generate the test signal for a channel in the maintenance mode. As a result, the maintenance may be completed without detecting a failure on the channel and without causing the controlled machine or process to enter a safe operating state as a result of such detection. According to another aspect of the invention, the safety controller may also be configured to generate a desired output signal on the channel in the maintenance mode. The desired output signal may replace an external control voltage further simplifying the maintenance process.

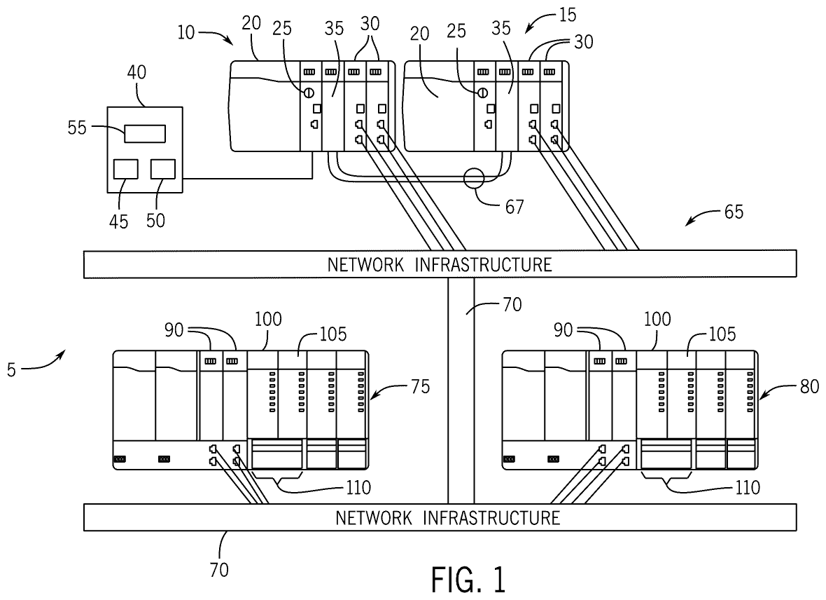

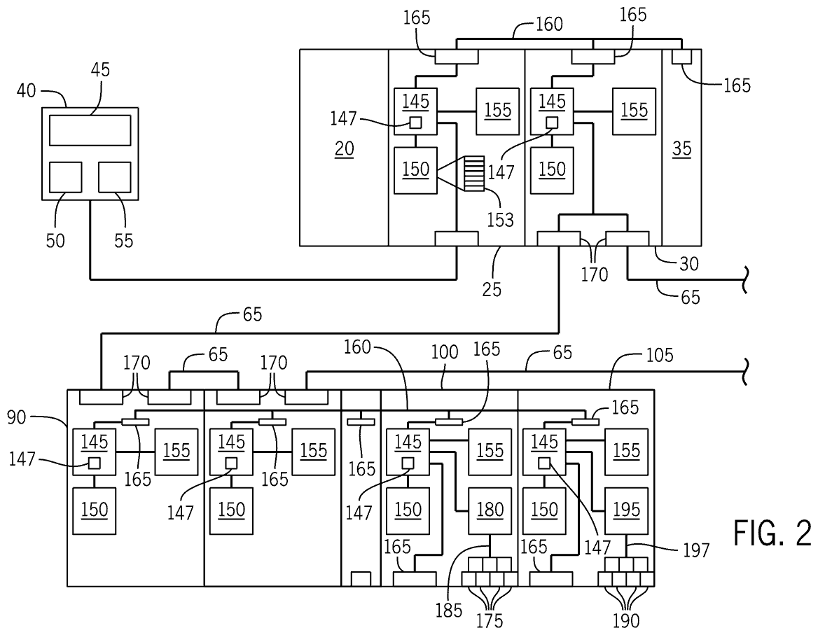

Turning first to FIG. 1 and FIG. 2, an exemplary industrial control system 5 with redundant subsystems is illustrated. The redundant subsystems may be provided to achieve a desired safety rating, where inputs and outputs are provided to two controllers and each controller monitors operation of the inputs and outputs as well as operation of the other controller to ensure correct operation of the control system 5. The illustrated control system 5 is an exemplary environment incorporating one embodiment of the present invention.

The industrial control system 5 includes a first controller chassis 10 and a second controller chassis 15. As illustrated, the first and second controller chassis 10 and 15 are modular and may be made up of numerous different modules. Additional modules may be added or existing modules removed and the first and second controller chassis 10 and 15 reconfigured to accommodate the new configuration. Optionally, either the first controller chassis 10 and/or the second controller chassis 15 may have a predetermined and fixed configuration. The first and second controller chassis 10 and 15 may have a single backplane or dual backplanes to facilitate communication between modules in the chassis. In the exemplary system shown, both the first and second controller chassis 10 and 15 include a power supply module 20, a controller module (or also referred to as simply “controller”) 25, and network bridge modules 30. Each controller chassis 10 and 15 is further shown with an additional module 35 that may be selected according to the application requirements. For example, the additional module 35 may be an analog or digital input or output module, which will be referred to herein generally as an IO module. Optionally, each chassis may be configured to have multiple additional modules 35 according to the application requirements. For ease of illustration, a single additional module 35 is illustrated and the illustrated module is a redundancy module to facilitate dual chassis controller redundancy.

An operator interface is shown connected to the industrial control system. The operator interface 40 can include a processing device 45 and an input device 50. The input device 50 can include, but is not limited to, a keyboard, touchpad, mouse, track ball, or touch screen. The operator interface can further include an output device 55. The output device 55 can include, but is not limited to, a display, a speaker, or a printer. It is contemplated that each component of the operator interface 40 may be incorporated into a single unit, such as an industrial computer, laptop, or tablet computer. It is further contemplated that multiple operator interfaces can be distributed about the industrial control system 5. The operator interface 40 may be used to display operating parameters and/or conditions of the controlled machine or process, receive commands from the operator, or change and/or load a control program or configuration parameters. An interface cable connects the operator interface 40 to the controller 25 on the first controller chassis 10.

The first and second controller chassis 10 and 15 are connected to other devices by a network 65 according to the application requirements. A redundant network topology is established by connecting the network bridge modules 30 of the controller chassis 10 and 15 to a redundant network infrastructure 70 by a suitable network of cables and/or network devices, such as router, switches, gateways, or the like. The network infrastructure 70 connects to a first remote chassis 75 and a second remote chassis 80. It is contemplated that the network cables may be custom cables configured to communicate via a proprietary interface or may be any standard industrial network, including, but not limited to, Ethernet/IP®, DeviceNet®, ControlNet®, or OPC UA®. The network bridge modules 30 and the network 70 are configured to communicate according to the protocol of the network to which it is connected and may be further configured to translate messages between two different network protocols. Dedicated interface cables 67 connect the redundancy modules 35 in each chassis to each other, providing a dedicated communication channel between the controller modules 25.

The first and second remote chassis 75 and 80 are positioned at varying positions about the controlled machine or process. As illustrated, the first and second remote chassis 75 and 80 are modular and may be made up of numerous different modules connected together in a chassis or mounted on a rail. Additional modules may be added or existing modules removed and the remote chassis 75 or 80 reconfigured to accommodate the new configuration. Optionally, the first and second remote chassis 75 and 80 may have a predetermined and fixed configuration. The first and second remote chassis 75 and 80 may have a single backplane or dual backplanes to facilitate communication between modules in the chassis. As illustrated, the first and second remote chassis 75 and 80 each includes a pair of network adapter modules 90, an input module 100, and an output module. Each network adapter module 90 is connected to the redundant network infrastructure 70 by a suitable network of cables. Each of the input modules 100 is configured to receive input signals from controlled devices, and each of the output modules 105 is configured to provide output signals to the controlled devices. Optionally, still other modules may be included in a remote chassis. Dual or triple redundant input modules 100 and/or output modules 105 may be included in a remote and/or controller chassis. It is understood that the industrial control network, industrial controller, and remote chassis may take numerous other forms and configurations without deviating from the scope of the invention. It should also be understood that an input module 100 and an output module 105 can form an IO module 110.

Referring next to FIG. 2, a portion of the exemplary industrial control system of FIG. 1 is illustrated in block diagram form. It is contemplated that each of the modules in the system may include a processor 145 and a memory 150. The processors 145 are configured to execute instructions and to access or store operating data and/or configuration parameters stored in the corresponding memory 150. The processors 145 are suitable processors according to the node requirements. It is contemplated that the processors 145 may include a single processing device or multiple processing devices executing in parallel and may be implemented in separate electronic devices or incorporated on a single electronic device, such as a field programmable gate array (FPGA) or application specific integrated circuit (ASIC). The processors 145 include random access memory 147 for processing runtime data. The memory devices 150 are non-transitory storage mediums that may be a single device, multiple devices, or may be incorporated in part or in whole within the FPGA or ASIC. Each of the modules also includes a clock circuit 155, and each clock circuit 155 is preferably synchronized with the other clock circuits 155 according to, for example, the IEEE-1588 clock synchronization standard. Each clock circuit 155 generates a time signal configurable to report the present time accurate to either microseconds or nanoseconds. Communication between modules mounted in the same chassis or contained within a single housing occurs via a backplane 160. The backplane 160 may be a single backplane or dual backplanes and include a corresponding backplane connector 165. Modules communicating via network media include ports 170 configured to process the corresponding network protocol. The input module 100 includes input terminals 175 configured to receive the input signals from the controlled devices. The input module 100 also includes any associated logic circuitry 180 and internal connections 185 required to process and transfer the input signals from the input terminals 175 to the processor 145. Similarly, each output module 105 includes output terminals 190 configured to transmit the output signals to the controlled devices. The output module 105 also includes any associated logic circuitry 195 and internal connections 197 required to process and transfer the output signals from the processor 145 to the output terminals 190.

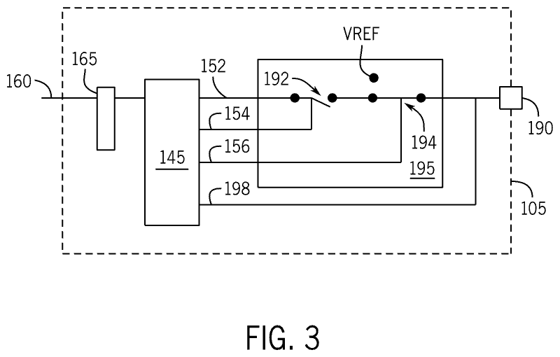

With reference next to FIG. 3, a portion of the logic circuitry 195 that may be included in an output module 105 is illustrated. The processor 145 transfers a desired output signal 152 for the channel from the processor to the logic circuit 195. A first switch 192 may be controlled by a first control signal 154, and a second switch 194 may be controlled by a second control signal 156. Under normal operation, the first and second switches 192, 194 are in a normally closed position, allowing the desired output signal 152 to be transferred between the processor 145 and the output terminal 190 for the channel. If the illustrated output channel is to be overridden for maintenance, the first control signal 154 and/or the second control signal 156 may be output from the processor 145 to alter the signal being output at the output terminal 190 for the corresponding channel. If the first control signal 154 is output, the first switch 192 opens, preventing the output signal 152 from reaching the output terminal 190. Further, the output side of the first switch 192 may be tied to ground when the first switch 192 opens forcing a logical zero output to be present at the output terminal 190. Optionally, the second control signal 156 may be output, causing the second switch 194 to change states. Rather than transferring the output signal 152 to the output terminal 190, the second switch 194 may cause a desired reference voltage, V_{ref}, to be supplied to the output terminal 190. The reference voltage, V_{ref}, may be provided as an override output signal to the output terminal. A channel feedback signal 198 may transmit the actual output signal present at the output terminal 190 back to the processor 145 for monitoring. For ease of illustration, a single channel is shown. The illustrated circuit may be replicated for multiple channels. Further, various different arrangements of switches and output signals may be provided to supply the desired output signal 152 and/or an override output signal to the output terminal 190 for a corresponding output channel.

In operation, the industrial control system 5 provides a safety controller with a maintenance mode that permits temporarily disabling of a test signal for an input or output channel. According to one aspect of the invention, the first controller chassis 10 may be configured as a standard controller and the second controller chassis 15 may be configured as a safety controller. The standard controller may be configured to execute a control program to receive the input signals and to generate output signals for desired operation of the controlled machine or process. The safety controller may include a copy of the control program and operate in parallel to monitor input signals and verify output signals are properly generated. The monitoring performed by the safety controller may be used to detect a failure in an input device, an actuator, or in one of the input or output channels in the standard controller. The safety controller may further include safety specific control routines monitoring, for example, safety devices such as emergency stop buttons or access point detection devices such as cameras, floor mats, and optical or infrared gates. The safety controller may be configured to execute the safety specific control routines either upon detection of a failure in the controlled system or upon activation of one of the safety devices to enter a predefined safe operating state.

According to another aspect of the invention, the first controller chassis 10 may be configured as a first controller and the second controller chassis 15 may be configured as a redundant controller in a high availability control system. Each of the first and second controller chassis 10, 15 may include multiple processors and/or multiple processing cores. A first processor or a first processing core may be configured as a standard controller, and a second processor or a second processing core may be configured as a safety controller. Operation of a standard controller or safety controller are substantially the same regardless of the configuration of controller chassis, processors, or processing cores performing the standard and safety control functions.

Turning next to FIGS. 3-5, operation of the maintenance mode will be described in more detail. An output module 105 includes multiple output channels. The output module 105 shown in FIG. 3 has a single output channel illustrated, but it is understood that the circuit may be duplicated for each channel. A controller module 25 executes a control program to generate desired output signals for each channel. The controller module 25 transmits the desired output signals to the output module 105 via the backplane 160. The processor 145 in the output module 105 receives the desired output signals for each channel in that corresponding output module.

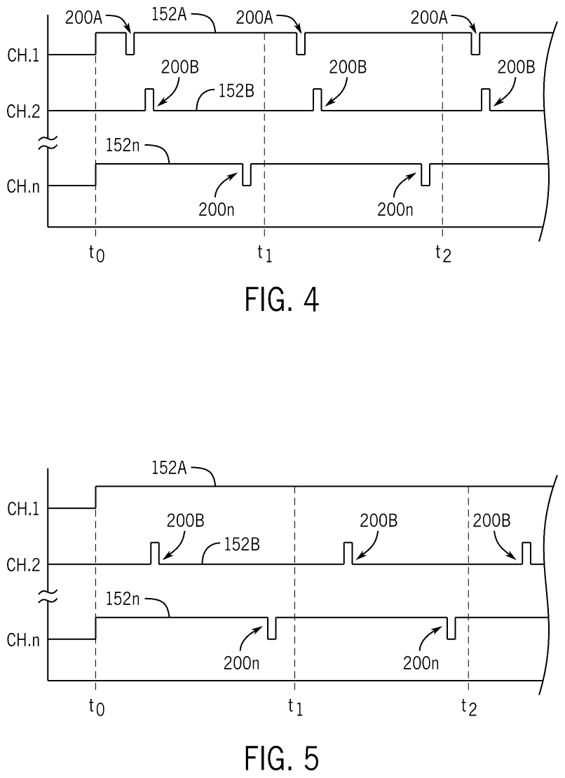

The output module 105 may have varying numbers of output channels according to the application requirements and the configuration of the output module. With reference to FIG. 4, the total number of output channels for an output module 105 is referred to as “n” channels. A first desired output signal 152A is a logical high, or a logical one. A second desired output signal 152B is a logical low, or a logical zero. The nth desired output signal 152n is again a logical high, or a logical one. At time, t₀, the output module 105 receives the desired output signals 152A-152n for each output channel and begins providing those desired output signals 152 to each output terminal 190.

The output module 105 is also configured to monitor operation of each output channel. At periodic intervals, denoted by times t₁ and t₂, a test signal 200 is provided to each output channel. According to the illustrated embodiment, a first test signal 200A is provided on the first output signal 152A. A second test signal 200B is provided on the second output channel 152B. An nth test signal 200n is provided on the nth output channel 152n. According to one aspect of the invention, the test signal 200 for each output signal 152 may be the same output signal supplied at different times within a periodic interval. A first periodic interval spans, for example, between t₀ and t₁, and a second periodic interval spans between t₁ and t₂. The periodic interval repeats indefinitely while the desired output signals 152 are supplied to each channel.

The test signal 200 may be introduced onto the desired output signal 152 by the first control signal 154 or by the second control signal 156. The desired output signal 152 is provided to each channel via the logic circuitry 195. During normal operation and with no test signal present, the first switch 192 and the second switch 194 are each maintained in a normally closed state, and the desired output signal 152 is provided directly to each output terminal 190. If the desired output signal 152 is a logical high signal, the test signal may be provided as the first control signal 154. The first control signal 154 opens the first switch 192 to temporarily bring the output signal to a logical low state. The first control signal 154 is then removed to again close the first switch 192 permitting the desired output signal 152 to be transmitted to the output terminal 190. Similarly, if the desired output signal 152 is a logical low signal, the test signal may be provided as the second control signal 156. The second control signal 164 transitions the second switch 194 to temporarily transmit the reference voltage, V_{ref}, or a logical high signal, to the output terminal. The second control signal 156 is then removed to again close the second switch 194 permitting the desired output signal 152 to be transmitted to the output terminal 190. Each of the first switch 192 and the second switch 194 may be implemented via transistors, such as field-effect transistors (FETs), metal-oxide semiconductor field-effect transistors (MOSFETs), bipolar junction transistors (BJTs), or any other suitable transistor or semiconductor switching device. The first and second switches 192, 194 are configured to transition between states with low switching delays, permitting a high rate of switching. Each output channel is maintained in the test state for a short period of time with respect to the response time of the output device connected to the output channel, such that the transition between states does not impact operation of the device connected to the output terminal 190.

According to another aspect of the invention, the test signal 200 may be introduced onto the desired output signal 152 by either the controller module or the processor 145 in the output module 105. A monitoring routine may be configured to periodically inject a test signal onto the desired output signals. The monitoring routine may read the present state of the desired output signal and invert the desired output signal for a short duration. This monitoring routine, therefore, introduces the test signal onto the desired output signal 152 without requiring an external control signal, or signals, and an external switch, or switches, to add the test signal onto each output signal.

Regardless of how the test signal 200 is introduced onto the desired output signal 152, the channel feedback signal 198 allows the processor 145 on the output module to verify correct operation of the output channel. The processor 145 compares the desired output signal 152 and/or the control signals 154, 156 to the channel feedback signal 198. The processor 145 determines proper operation of the output channel when the channel feedback signal 198 matches the desired output signal 152 and when the channel feedback signal 198 changes state as a result of the test signal 200.

Turning next to FIG. 5, the processor 145 is further operative to disable the diagnostic test signal 200 for one or more of the output channels when a maintenance mode is desired. According to a first aspect of the invention, one or more of the channels must be identified to enter the maintenance mode. As discussed above, the industrial control system may include one or more operator interfaces 40. The operator interface may be a portable computing device, such as a laptop, notebook, tablet, smart phone, or other portable computing device including an application executing on the portable computing device to interface with the industrial control system. The portable computing device may be permanently located at a station, movable about the controlled machine or process, or temporarily brought to the controlled machine or process for maintenance and then removed. Optionally, the operator interface 40 may also be a Human Machine Interface (HMI) or other industrial computer permanently located at the controlled machine or process. The application executing on the operator interface 40 may allow a technician to identify a particular module and then select one or mor channels present on the module for which maintenance mode is desired. Such selection may be desired for an input or output channel on which scheduled maintenance may not be predictable. Alternately, an input or output channel may be designed for maintenance scheduled, for example, at periodic times or after predefined durations of operation. The control program may be configured to receive an input from a selection device such as a switch, a timer, a dial, or any other suitable device to provide an input signal to the control program indicating maintenance is required. When the control program receives the input, it may first generate a message to an operator or technician indicating maintenance is required. The operator or technician may acknowledge the message and enter a maintenance mode. Optionally, the control program may directly enter a maintenance mode upon receipt of the input signal. The control program has a predefined channel or channels to be overridden as a result of the input signal indicating maintenance is required.

When a channel is to be overridden, the test signal 200 for that channel is temporarily disabled. According to the example illustrated in FIG. 5, Channel 1 is identified as the channel to be overridden. A desired output signal 152A is still provided at the output channel. However, the processor 145 skips channel one for the application of the test signal 200A. The test signal 200B to 200n is still applied to each of the other channels (i.e., Channel 2 to Channel n).

By disabling the test signal 200 to a channel, inadvertent detection of a failure in that channel is prevented when maintenance is being performed on a device connected to that channel. In some applications, it is desirable to provide a fixed voltage to a device during maintenance such that the controlled machine or process may continue operating while maintenance is being performed. With reference again to FIG. 3, the processor may generate a control signal 156 to control the second switch 194 in the logic circuit 195 to connect to a reference voltage, V_{ref}. This reference voltage, V_{ref}, is provided at the output terminal 190 for as long as the control signal 156 sets the second switch 194. In applications requiring a fixed voltage during maintenance, the control signal 156 may be set from the operator interface 40 in tandem with selecting a channel to be overridden as discussed above.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A module for a safety controller, the module comprising:
a plurality of channels for either input signals or output signals;
a plurality of terminals, wherein each terminal corresponds to one of the plurality of channels;
a processor operative to:
generate at least one test signal,
provide the at least one test signal to each of the plurality of channels to detect proper operation of each of the plurality of channels while either receiving the input signals or providing the output signals at each of the plurality of terminals, and
selectively disable the at least one test signal provided to one of the plurality of channels.

2. The module of claim 1, wherein each of the plurality of channels provides an output signal.

3. The module of claim 2, wherein the processor is further operative to:
receive a plurality of desired output signals from the safety controller, wherein each of the plurality of desired output signals corresponds to one of the plurality of channels;
identify an override channel, selected from the plurality of channels;
provide the desired output signal to each of the plurality of channels except the override channel; and
selectively disable the at least one test signal to the override channel.

4. The module of claim 3, wherein the processor is further operative to provide an override output signal to the override channel.

5. The module of claim 4, wherein the safety controller is in communication with an operator interface to receive an identification of the override channel and the override output signal.

6. The module of claim 4, wherein a control program executing on the safety controller receives an input signal identifying the override channel.

7. The module of claim 1, wherein each of the plurality of channels receives an input signal.

8. The module of claim 7, wherein the processor is further operative to:
identify an override channel, selected from the plurality of channels;
selectively disable the at least one test signal to the override channel;
receive the input signal for each channel from each of the plurality of terminals; and
transmit the input signal received for each channel to the safety controller.

9. The module of claim 8, wherein the processor is further operative to transmit an override input signal to the safety controller for the override channel.

10. A method for disabling a diagnostic test for a module in a safety controller, the method comprising:
identifying an override channel for the module, wherein the override channel is selected from a plurality of channels for either input signals or output signals;
generating at least one test signal;
providing the at least one test signal to each of the plurality of channels to detect proper operation of each of the plurality of channels while either receiving the input signals or providing the output signals; and
selectively disabling the at least one test signal provided to the override channel.

11. The method of claim 10, wherein each of the plurality of channels provides an output signal.

12. The method of claim 11, further comprising the steps of:
receiving a plurality of desired output signals from the safety controller, wherein each of the plurality of desired output signals corresponds to one of the plurality of channels; and
providing the desired output signal to each of the plurality of channels except the override channel.

13. The method of claim 12, further comprising the step of providing an override output signal to the override channel.

14. The method of claim 13, further comprising the step of receiving an identification of the override channel and the override output signal at the safety controller from an operator interface.

15. The method of claim 13, further comprising the steps of:
executing a control program on the safety controller; and
receiving an input signal in the control program identifying the override channel.

16. The method of claim 10, wherein each of the plurality of channels receives an input signal.

17. The method of claim 16, further comprising the steps of:
receiving the input signal for each channel from each of a plurality of terminals, wherein one of the plurality of terminals corresponds to each channel; and
transmitting the input signal received for each channel to the safety controller.

18. The method of claim 17, further comprising the step of transmitting an override input signal to the safety controller for the override channel.

19. A system for disabling a diagnostic test for a module in a safety controller, the system comprising:
a controller module, including:
a memory storing a plurality of instructions, and
a processor configured to execute the plurality of instructions to generate a plurality of output signals;
an output module, including
a plurality of channels;
a plurality of terminals, wherein each terminal corresponds to one of the plurality of channels;
a processor operative to:
receive the plurality of output signals from the controller module,
generate at least one test signal,
provide the at least one test signal to each of the plurality of channels to detect proper operation of each of the plurality of channels while receiving the plurality of output signals, and
selectively disable the at least one test signal provided to one of the plurality of channels.

20. The system of claim 19, wherein the processor in the output module is further operative to:
identify an override channel, selected from the plurality of channels;
provide the plurality of output signals to each of the plurality of channels except the override channel;
selectively disable the at least one test signal to the override channel; and
provide an override output signal to the override channel.
